(19) United States
(12) Patent Application Publication
(10) Pub. No.: US 2026/0195344 A1
(43) Pub. Date: Jul. 9, 2026

(54) SYSTEM AND METHOD FOR AUTOMATIC IDENTIFICATION OF POTENTIAL SERIOUS INJURIES AND FATALITIES FROM INCIDENT RECORDS

(71) Applicant: VelocityEHS Holdings Inc., Chicago, IL (US)

(72) Inventors: Julia Penfield, Seattle, WA (US); Pulkit Trushantkumar Parikh, Oakville (CA)

(21) Appl. No.: 19/009,034

(22) Filed: Jan. 3, 2025

(51) Int. Cl. G06F 16/28; G06F 40/117; G06Q 10/10

(52) U.S. Cl. CPC G06F 16/285; G06F 40/117; G06Q 10/10

(57) ABSTRACT

A computing system and method for identifying potential serious injuries and fatalities (PSIF) incidents from incident records. An example system may include a computing device configured to obtain an incident record, identify fields included in the incident record in connection with a set of descriptors, generate a textual description of the incident record based on selected fields of the incident record corresponding to the set of descriptors, determine parameters and natural language instructions for using a language model to determine whether the incident record is a PSIF incident, instruct the language model to perform a machine-learning based binary classification to generate a PSIF or non-PSIF label and a rationale for the incident record based upon the parameters and natural language instructions and the textual description of the incident record, and generate data for a display device to indicate the PSIF or non-PSIF label and the rationale thereof.

### FIELD OF TECHNOLOGY

The present disclosure generally relates to a system and method for workplace safety management automation, and more particularly relates to an artificial intelligence (AI)/machine learning (ML) based computing system and method for automatically identifying potential serious injuries and fatalities (PSIF) incidents based at least upon obtained incident reports or records.

### BACKGROUND

Safety incidents have always been a crucial risk in workspaces, especially industrial sites. In the last few decades, significant efforts have been dedicated to incident control measures to reduce the rate of safety incidents. Despite all these efforts, the rate of decline in serious injuries and fatalities (SIFs) has been considerably lower than the rate of decline for non-critical incidents. This observation has led to a change of risk reduction paradigm for safety incidents. Under the new paradigm, more focus has been allocated to reducing the rate of critical/SIF incidents, as opposed to reducing the count of all incidents.

One of the challenges in reducing the number of SIF incidents is the proper identification of the risk prior to materialization. One of the reasons for risk identification being a challenge is that companies usually only focus on incidents where SIF did occur reactively, and incidents that did not cause SIF but had the potential to do so go unnoticed. Identifying these potentially significant incidents, referred to as PSIF incidents, would enable companies to work on identifying critical risk and taking steps to prevent them preemptively. However, flagging PSIF incidents requires all incident reports to be analyzed individually by experts and hence significant investment, which is often not affordable, especially for small and medium sized companies.

Accordingly, there is a need for an AI/ML based approach for automatically identifying PSIF incidents at workplaces from incident records.

### SUMMARY

In one aspect, the present disclosure relates to a system deployed within a communication network for identifying PSIF incidents from incident records. An example system may comprise a computing device, comprising: a non-transitory computer readable storage medium storing instructions; and a processor coupled to the non-transitory computer readable storage medium and configured to execute the instructions to: obtain an incident record, identify fields included in the incident record in connection with a set of predetermined field descriptors, generate a textual description of the incident record based on selected fields of the incident record corresponding to the set of predetermined field descriptors, determine a plurality of parameters and natural language instructions for using a language model to determine whether the incident record is a PSIF incident, instruct the language model to perform a machine-learning based binary classification to generate a PSIF label or a non-PSIF label for the incident record based at least upon the plurality of parameters and natural language instructions and the textual description of the incident record, instruct the language model to generate a rationale explaining a determination of the PSIF label or the non-PSIF label for the incident record, and generate data for a display device to indicate the PSIF label or the non-PSIF label for the incident record and the rationale thereof.

In some embodiments, the processor of the computing device may be further configured to execute the instructions to: generate a first user interface element for the display device to allow an acceptance of the PSIF label or the non-PSIF label for the incident record; and generate a second user interface element for the display device to allow a rejection of the PSIF label or the non-PSIF label for the incident record.

The processor of the computing device may be further configured to execute the instructions to: receive one or more labeled PSIF incident records; and instruct the language model to perform the machine-learning based binary classification to generate the PSIF label or the non-PSIF label for the incident record based at least upon the plurality of parameters and natural language instructions, the textual description of the incident record, and the one or more labeled PSIF incident records.

In some implementations, the natural language instructions may be configured to instruct the language model to perform in-context learning based at least upon the one or more labeled PSIF incident records in classifying the PSIF label or the non-PSIF label for the incident record. The incident record may include a plurality of heterogeneous fields including at least one of: a unstructured text input with a number of unique values, a categorical input with a number of unique textual values, a quantity-based input including numeric values and associated textual information, and date and time information relating to a workplace incident. In an embodiment, the plurality of parameters may instruct the language model to produce a structured response to represent the PSIF label or the non-PSIF label for the incident record and the rationale thereof using hypertext markup language (XML) tags. In another embodiment, the plurality of parameters may set a tunable parameter of the language model to produce the structured response maximally deterministic.

In additional embodiments, the processor of the computing device may be further configured to execute the instructions to transmit the plurality of parameters and natural language instructions and the textual description of the incident record to the language model via an application programming interface (API).

The processor of the computing device may be further configured to execute the instructions to receive the PSIF label or the non-PSIF label for the incident record and the rationale thereof via the API. The language model may comprise at least one generative pre-trained transformer model.

In accordance with another aspect, the present disclosure relates to a computer-implemented method for identifying PSIF incidents from incident records. An example computer-implemented method may comprises obtaining, by a processor of a computing device, an incident record; identifying, by the processor of the computing device, fields included in the incident record in connection with a set of predetermined field descriptors; generating, by the processor of the computing device, a textual description of the incident record based on selected fields of the incident record corresponding to the set of predetermined field descriptors; determining, by the processor of the computing device, a plurality of parameters and natural language instructions for using a language model to determine whether the incident record is a PSIF incident; instructing, by the processor of the computing device, the language model to perform a machine-learning based binary classification to generate a PSIF label or a non-PSIF label for the incident record based at least upon the plurality of parameters and natural language instructions and the textual description of the incident record; instructing, by the processor of the computing device, the language model to generate a rationale explaining a determination of the PSIF label or the non-PSIF label for the incident record; and generating, by the processor of the computing device, data for a display device to indicate the PSIF label or the non-PSIF label for the incident record and the rationale thereof.

In certain embodiments, the computer-implemented method may further comprise: generating, by the processor of the computing device, a first user interface element for the display device to allow an acceptance of the PSIF label or the non-PSIF label for the incident record; and generating, by the processor of the computing device, a second user interface element for the display device to allow a rejection of the PSIF label or the non-PSIF label for the incident record.

Furthermore, the computer-implemented method may further comprise receiving one or more labeled PSIF incident records; and instructing the language model to perform the machine-learning based binary classification to generate the PSIF label or the non-PSIF label for the incident record based at least upon the plurality of parameters and natural language instructions, the textual description of the incident record, and the one or more labeled PSIF incident records.

In another embodiment, the natural language instructions may be configured to instruct the language model to perform in-context learning based at least upon the one or more labeled PSIF incident records in classifying the PSIF label or the non-PSIF label for the incident record.

The incident record may include a plurality of heterogeneous fields including at least one of: a unstructured text input with a number of unique values, a categorical input with a number of unique textual values, a quantity-based input including numeric values and associated textual information, and date and time information relating to a workplace incident.

In an additional embodiment, the plurality of parameters may instruct the language model to produce a structured response to represent the PSIF label or the non-PSIF label for the incident record and the rationale thereof using XML tags. The plurality of parameters may also set a tunable parameter of the language model to produce the structured response maximally deterministic.

In yet another embodiment, the computer-implemented method may further comprise transmitting, by the processor of the computing device, the plurality of parameters and natural language instructions and the textual description of the incident record to the language model via an API.

Moreover, the computer-implemented method may further comprise receiving, by the processor of the computing device, the PSIF label or the non-PSIF label for the incident record and the rationale thereof via the API. The language model may comprise at least one generative pre-trained transformer model.

The above simplified summary of example aspects serves to provide an understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a diagram of an AI/ML based computing system for automatically identifying PSIF incidents at workplaces from incident records, according to an exemplary aspect of the present disclosure;

FIG. 2 illustrates a block diagram of an example computing server system, according to an exemplary aspect of the present disclosure;

FIG. 3 illustrates a number of column categories describing various incidents, according to an exemplary aspect of the present disclosure;

FIG. 4 illustrates a flowchart of an AI/ML based PSIF identification method, according to an exemplary aspect of the present disclosure;

FIG. 5 illustrates a number of field descriptors of incident record fields, according to an exemplary aspect of the present disclosure;

FIG. 6 illustrates an example textual representation of an incident record from select fields, according to an exemplary aspect of the present disclosure;

FIG. 7 illustrates predicted PSIF labels and the associated rationale for four incident records represented using a subset of incident record fields, according to an exemplary aspect of the present disclosure; and

FIG. 8 illustrates an example user interface for PSIF identification, according to an exemplary aspect of the present disclosure.

### DETAILED DESCRIPTION

Various aspects of the present disclosure will be described with reference to the drawings, wherein like reference numerals are used to refer to like elements throughout. In the following description, for purposes of explanation, numerous specific details are set forth in order to promote a thorough understanding of one or more aspects of the present disclosure. It may be evident in some or all instances, however, that any aspects described below can be practiced without adopting the specific design details described below.

In accordance with aspects, the present disclosure leverages advanced generative AI/ML methods to develop a tool that not only determines whether a given incident is a PSIF incident but also provides a rationale for the determination, thereby allowing a user to make an informed decision about accepting or rejecting the tool's determination. In an embodiment, given a record of an incident, a binary classifier may be implemented to automatically predict whether the incident may have the potential for serious injuries or fatalities. Binary classification is a type of ML algorithm used to classify data into one of two categories. It predicts a binary outcome, where the result may either be positive or negative. For example, binary classification of an incident record may be PSIF or non-PSIF. Additionally, a brief explanation of the reasoning behind the prediction (why the incident was deemed PSIF or non-PSIF) may be provided. As will be described fully below, an example incident record of the present disclosure may be composed of a number of heterogeneous fields. If there are any labeled PSIF incident records available for training the PSIF classifier of the present disclosure, they may serve as inputs optionally.

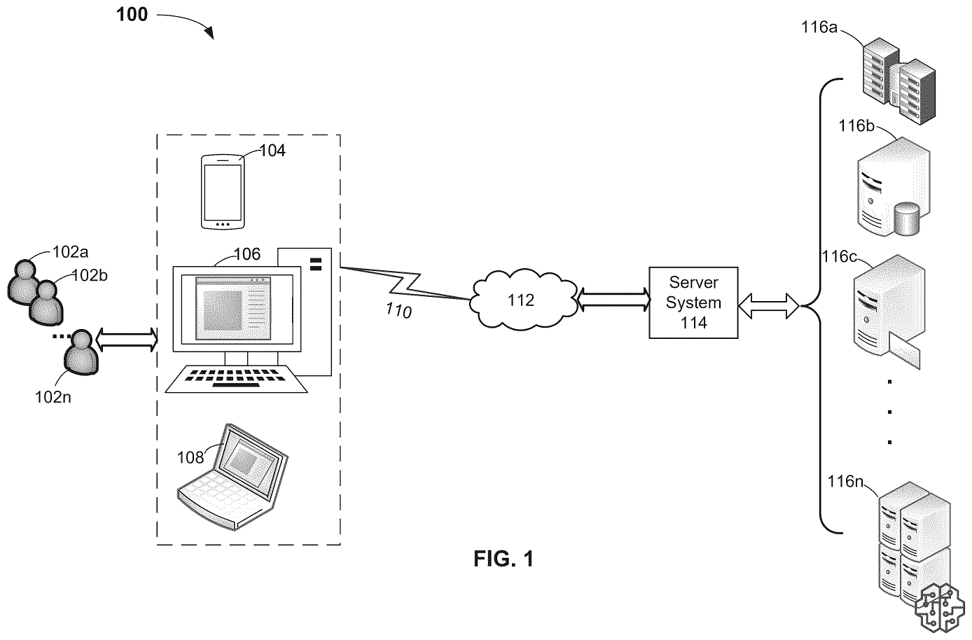

According to various aspects, FIG. 1 illustrates a diagram of a computing system 100, deployed within a server-based computing environment and communication network, for receiving a record or report of an incident and automatically determining whether the obtained incident is a PSIF incident and providing a rationale for the determination. In one embodiment, a user 102a, 102b, . . . 102n may use a selected computing device or system 104, 106, 108 to input a workplace incident record which may be transmitted to a server system 114, using suitable communication protocol(s) 110 and at least one communication network 112. The input to the computing system 100 of the present disclosure may optionally include a plurality of labeled PSIF incident records for training the AI/ML models and the PSIF classifier associated with the computing system 100 for PSIF incident identification.

The communication network 112 may generally include a geographically distributed collection of computing devices or data points interconnected by communication links and segments for transporting signals and data therebetween. The communication protocol(s) 110 may generally include a set of rules defining how computing devices and networks may interact with each other, such as frame relay, Internet protocol (IP), transmission control protocol (TCP), user datagram protocol (UDP), hypertext transfer protocol (HTTP). It should be appreciated that the computing system 100 of the present disclosure may use any suitable communication network, ranging from local area networks (LANs), wide area networks (WANs), cellular networks, to overlay networks and software-defined networks (SDNs), a packet data network (e.g., the Internet), mobile telephone networks (e.g., cellular networks, such as 4G or 5G), Plain Old Telephone (POTS) networks, and wireless data networks (e.g., Institute of Electrical and Electronics Engineers (IEEE) 802.11 family of standards known as Wi-Fi®, WiGig®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, virtual private networks (VPN), Bluetooth, Near Field Communication (NFC), or any other suitable network.

The server system 114 may be configured to train, host, incorporate or make an application programming interface (API) call to at least one of a plurality of computing systems 116a, 116b, 116c, . . . 116n to process a received incident record and determine whether the incident record is a PSIF or not. In a preferred embodiment, the plurality of computing systems 116a, 116b, 116c, . . . 116n may include one or more large language models (LLMs) and/or deep learning or ML models that may be or have been trained for processing received prompts and/or data to identify PSIF incidents and provide a rationale behind such determination. An LLM is an AI model that may be capable of processing and generating human-like text based on the information it has learned from vast amounts of training data. The term “large” refers to the size of these models in terms of the number of parameters or weights, which are the values that the model learns during training to make predictions and generate text. LLMs may have millions, billions (or even more) parameters, which enable such models to capture complex patterns and nuances in language that, in turn, allow these models to understand and generate more natural-sounding text (relative to previous approaches). Examples of LLMs include the generative pre-trained transformer models (e.g., GPT-3, GPT-4, Codex), Pathways Language Model (PaLM), Gemini, Language Model for Dialogue Applications (LaMDA), Bard, Large Language Model Meta Artificial Intelligence (LLaMA), Claude, Orca, Turing-NLG, Command R, Mistral, Mixtral, Grok, BigScience Large Open-science Open-access Multilingual Language Model (BLOOM), Luminous, Titan, Tongyi Qianwen, Enhanced Representation through Knowledge Integration (ERNIE), PanGu, NeMo, XGen, StableLM, Character LLM, and even non-generative examples such as bidirectional encoder representations from Transformers (BERT), etc.

In some embodiments, the server system 114 may be Cloud-based or an on-site server. The term “server” generally refers to a computing device or system, including processing hardware and process space(s), an associated computer readable storage medium such as a memory device or database, and, in some instances, at least one database application as is well known in the art. The server system 114 may provide functionalities for any connected devices such as sharing data or provisioning resources among multiple client devices, or performing computations for each connected client device. According to one embodiment, within a Cloud-based computing architecture, the server system 114 may provide various Cloud computing services using shared resources. Cloud computing may generally include Internet-based computing in which computing resources are dynamically provisioned and allocated to each connected computing device or other devices on-demand, from a collection of resources available via the network or the Cloud. Cloud computing resources may include any type of resource, such as computing, storage, and networking. For instance, resources may include service devices (firewalls, deep packet inspectors, traffic monitors, load balancers, etc.), computing/processing devices (servers, central processing units (CPUs), graphics processing units (GPUs), random access memory, caches, etc.), and storage devices (e.g., network attached storages, storage area network devices, hard disk drives, solid-state devices, etc.). In addition, such resources may be used to support virtual networks, virtual machines, databases, applications, etc. The term “storage device” or “database,” as used herein, may refer to a database (e.g., relational database management system (RDBMS) or structured query language (SQL) database), or may refer to any other data structure, such as, for example a comma separated values (CSV), tab-separated values (TSV), JavaScript Object Notation (JSON), eXtendible markup language (XML), TeXT (TXT) file, flat file, spreadsheet file, and/or any other widely used or proprietary format. In some embodiments, one or more of the databases or data sources may be implemented using one of relational databases, flat file databases, entity-relationship databases, object-oriented databases, hierarchical databases, network databases, NoSQL databases, and/or record-based databases.

Cloud computing resources accessible using any suitable communication network (e.g., Internet) may include a private Cloud, a public Cloud, and/or a hybrid Cloud. Here, a private Cloud may be a Cloud infrastructure operated by an enterprise for use by the enterprise, while a public Cloud may refer to a Cloud infrastructure that provides services and resources over a network for public use. In a hybrid Cloud computing environment, which uses a mix of on-premises, private Cloud and third-party, public Cloud services with orchestration between the two platforms, data and applications may move between private and public Clouds for greater flexibility and more deployment options. Some example public Cloud service providers may include Amazon (e.g., Amazon Web Services® (AWS)), IBM (e.g., IBM Cloud), Google (e.g., Google Cloud Platform), and Microsoft (e.g., Microsoft Azure®). These providers provide Cloud services using computing and storage infrastructures at their respective data centers and access thereto is generally available via the Internet. Some Cloud service providers (e.g., Amazon AWS Direct Connect and Microsoft Azure ExpressRoute) may offer direct connect services and such connections typically require users to purchase or lease a private connection to a peering point offered by these Cloud providers.

In one embodiment, an application, which may include a mobile or web-based application (e.g., native iOS or Android Apps), may be downloaded and installed on the selected computing device or system 104, 106, or 108 for interacting with each user 102a, 102b . . . 102n which includes but not limited to employers, ergonomic risk experts, injury prevention specialists, system/network administrators, software developers, and other end-users. Automated agents, scripts, playback software, and the like acting on behalf of one or more people may also be user 102a, 102b . . . 102n. Such a user-facing application of the computing system 100 may include a plurality of modules and libraries executed and controlled by the microcontroller or processor of the hosting computing device or system 104, 106, 108 for performing functions locally on each computing device or making remote calls (e.g., API calls) to the server system 114 to access specific functionalities. The division of labor between local execution and server-side operations depends on how each module or library is designed and what its functions require.

According to some implementations, one or more libraries downloaded on the selected computing device or system 104, 106, 108 may be configured to perform all their operations locally without relying on the server system 114. That is, once a library is installed, it may access the resources and computing power available on each computing device 104, 106, 108 to execute tasks. For example, certain libraries may be configured to perform computations locally using each computing device's CPU/GPU. Further, file handling libraries may be configured to process files stored on the local device. If pre-trained ML models are included in the library, they may run locally, depending on each device's capabilities. Local execution of these libraries may not require e.g., Internet connection. Since there is no network latency, execution is faster for these local operations. Further, there is a greater control over data privacy, since no data needs to be sent to an external server. However, limited by each device's hardware (e.g., memory, processing power), local execution may involve downloading potentially large libraries, models, or datasets.

According to another embodiment, remote execution (server-side processing) may be implemented, and libraries downloaded on each computing device 104, 106, 108 may make remote calls (e.g., API calls) to the server system 114 to access certain functionalities, for example, when the functions a library provides are too resource-intensive for local execution or require access to constantly updated data (e.g., real-time services, large-scale models, or databases). In this case, the library acts as a client-side interface that makes API requests to the server system 114 to perform specific tasks.

In one example, a library may interface with services like OpenAI's GPT, Google Cloud AI, Claude Sonnet, or Amazon S3, where the computation may be carried out on the server system 114, and the selected computing device 104, 106, 108 sends requests and receives results. In another example, libraries like AWS SDK, Google Cloud SDK may allow interaction with Cloud storage to upload, retrieve, and manipulate data on the Cloud.

Server-side processing may offload heavy computation to powerful servers (e.g., at least one of a plurality of computing systems 116a, 116b, 116c, . . . 116n), provide access to real-time data and updated services, and being device-agnostic by working even on devices with limited resources (smartphones, tablets, etc.).

According to additional embodiments, libraries implemented on each selected computing device 104, 106, 108 may adopt a hybrid model, where some operations or computations may be performed locally, while more complex or resource-intensive tasks are offloaded to the server system 114. For example, basic computations, preprocessing, or user interface elements may be handled locally, while complex processing, data retrieval, or heavy computations (e.g., running large AI models and LLMs, or interacting with databases) may be carried out via the server system 114.

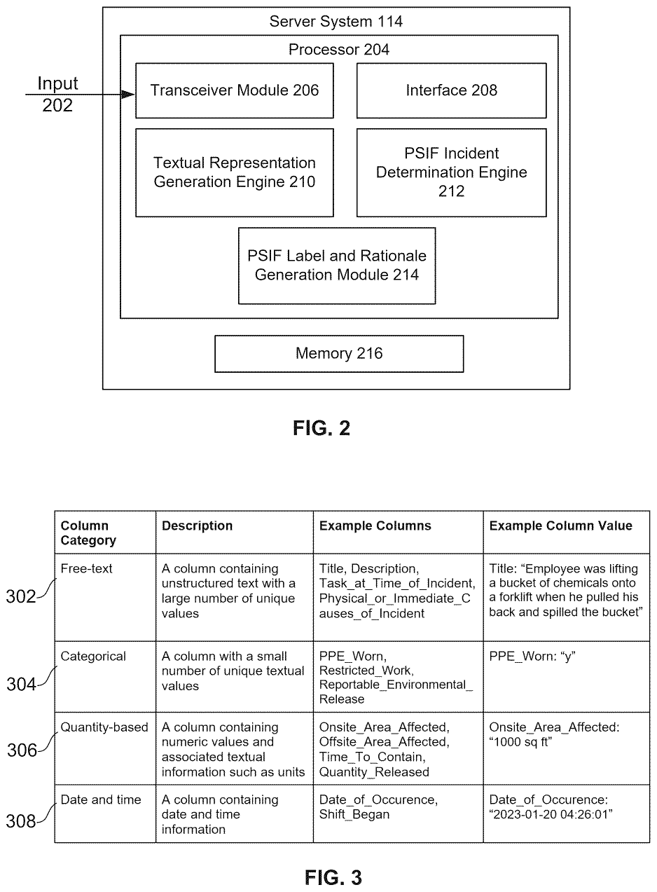

Referring now to FIG. 2, at least one processor 204 of the server system 114 may be configured to control and execute a plurality of modules and engines which may include a transceiver module 206, an interface 208, a textual representation generation engine 210, a PSIF incident determination engine 212, and a PSIF label and rationale generation module 214. The term “module” and “engine” as used herein refers to a real-world device, component, or arrangement of components and circuitries implemented using hardware, such as by an application specific integrated circuit (ASIC) or field-programmable gate array (FPGA), for example, or as a combination of hardware and software, such as by a microprocessor system and a set of instructions to implement the module's or engine's functionality, which (while being executed) transform the microprocessor system into a special purpose device. A module or engine may also be implemented as a combination of the two, with certain functions facilitated by hardware alone, and other functions facilitated by a combination of hardware and software. Each module or engine may be realized in a variety of suitable configurations, and should not be limited to any example implementation exemplified herein.

Memory 216, which is coupled to processor 204, may be configured to store at least a portion of information obtained by the server system 114. In one aspect, memory 216 may be a non-transitory computer readable medium configured to store at least one set of data structures or instructions (e.g., software) embodying or utilized by at least one of the techniques or functions described herein. It should be appreciated that the term “non-transitory computer readable medium” may include a single medium or multiple media (e.g., one or more caches) configured to store at least one instruction. The term “computer readable medium” may include any medium that is capable of storing, encoding, or carrying instructions for execution by all modules or engines of the server system 114 and that cause these modules or engines to perform at least one of the techniques of the present disclosure, or that is capable of storing, encoding or carrying data structures used by or associated with such instructions. Non-limiting computer readable medium examples may include solid-state memories, and optical and magnetic media. Specific examples of computer readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks.

The transceiver module 206 of the server system 114 may be controlled by processor 204 to exchange various information and data with other computing devices deployed within the communication network 112 and connected with the server system 114 (e.g., computing device or system 104, 106, or 108 and/or the computing systems 116a, 116b, 116c, . . . 116n of FIG. 1).

The interface 208 may be controlled by processor 204 to provide necessary communication and interaction functions between various software components, hardware components, or users. For example, the interface 208 may provide a set of functions or protocols for other components to interact with a particular system or service, or be a physical device or circuitry that connects different electronic components or systems. For example, the user-facing application downloaded and installed on each hosting computing device or system 104, 106, or 108 of FIG. 1 may be a thin client device/terminal/application deployed within the computing system 100 and may be configured to perform certain preliminary processing of data relating to any received information from user 102a, 102b . . . 102n. Thereafter, the processed data may be transmitted to the server system 114 for further processing. In one embodiment, interface 208 may include an API interface configured to make one or more API calls therethrough. For example, the computing systems 116a, 116b, 116c, . . . 116n of FIG. 1 may include one or more LLMs and the API interface of the server system 114 may exchange data with each LLM's API. On the other hand, the server system 114 may include an API gateway device (not shown) configured to receive and process API calls from various connected computing devices deployed within the system 100 (e.g., an operating system, a library, a device driver, an API, an application program, software or other module). Such an API gateway device may specify one or more functions, methods, classes, objects, protocols, data structures, formats and/or other features of the server system 114 that may be used by the mobile or web-based application. For example, the API interface included in the interface 208 may define at least one calling convention that specifies how a function associated with the server system 114 receives data and parameters from a requesting device/system and how the function returns a result to the requesting device/system. It should be appreciated that the server system 114 may include additional functions, methods, classes, data structures, and/or other features that are not specified through the API interface and are not available to a requesting computing device.

According to some embodiments, data considered for analysis and experimentation by the server system 114 of the present disclosure may include approximately 935K records (rows), each row providing information about an incident occurred at a workplace. The server system 114 may process multiple incidents (rows) in parallel for improved efficiency. These incidents may be described via a variety of columns (also referred to as fields), ranging from those involving unstructured, free-flowing text to quantity-based fields. An example dataset of the present disclosure may comprise a total of 61 columns. Referring to FIG. 3, four example column categories are illustrated. Specifically, a first column category may include free-text 302 which contains unstructured text with a large number of unique values. Example columns may include a title of the incident, a description of the incident, the task performed at the time of the incident, and the physical or immediate causes of the incident. An example title of the incident in the free-text category 302 may indicate: “Employee was lifting a bucket of chemicals onto a forklift when he pulled his back and spilled the bucket.”

A second column category may be categorical 304, referring to a column with a small number of unique textual values. Categorical variables are qualitative values and do not imply a numerical ordering, unlike quantitative values, which are measured in terms of numbers. Usually, a categorical variable may be a value taken from a limited set of values. Example columns of a categorical column 304 may indicate whether personal protective equipment (PPE) was worn by a worker during an incident, whether the incident relates to restricted work, and any reportable environmental release. An example categorical column value may indicate “PPE worn: ‘y’”.

A third column category may be quantity-based 306, which contains numeric values and associated textual information such as units. Example columns may indicate onsite area affected by a workplace incident, offsite area affected, time to contain, and quantity released. An example column value may indicate “onsite area affected: 1000 sq ft.”

A fourth category may include date and time information 308 relating to an incident at a workplace. Example columns may indicate the date of occurrence of the incident and when a shift began. An example column value may indicate “date of occurrence: ‘2023-01-20 04:26:01’”.

It should be appreciated that additional column categories may be added to describe various incidents occurred at workplaces with respect to the nature, context, extent and details of each incident, and the potential root causes.

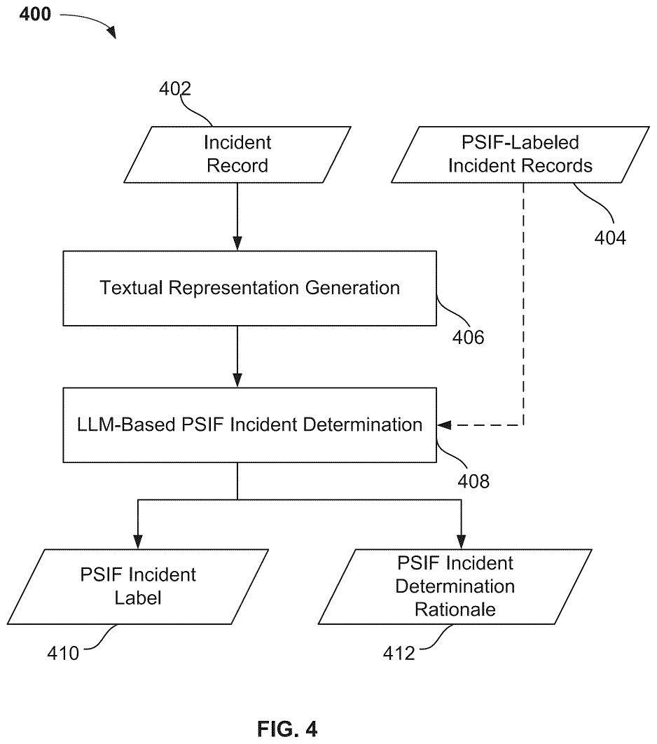

FIG. 4 illustrates a flowchart 400 of an AI/ML based PSIF incident identification carried out by the server system 114 of the present disclosure. According to some implementations, at least one LLM, such as GPT-40 from OpenAI or Claude 3.5 Sonnet from Anthropic, may be incorporated, hosted and trained by the server system 114.

Referring now to FIGS. 2 and 4, the transceiver module 206 of the server system 114 may be controlled by the processor 204 to receive a request or input 202, via the interface 208, for identifying PSIF incidents. Such an input 202 may include at least one incident report or record 402 in the form of a document, an email, a text message, a voice message, an image, a video, etc. Each incident record 402 may be composed of a number of heterogeneous fields, as described above with respect to FIG. 3.

The textual representation generation engine 210 may be configured to generate 406 a textual representation of the incident record 402. For efficient LLM processing, the textual representation generation engine 210 may condense inputs by extracting the relevant parts of each incident record (e.g., descriptions, context, severity indicators) to minimize input length. Incident records may be formatted consistently to reduce complexity, e.g., using predefined templates. If individual incident records are long, the textual representation generation engine 210 may split them into smaller chunks that retain contextual integrity and ensure chunks do not exceed the model's token limit.

In an aspect, a subset of the incident record fields as shown in FIG. 3 may be identified and utilized for the generation of this textual representation. For example, the textual representation generation engine 210 may process each incident record 402 to impute missing values and rebalance data set (e.g., equalizing sample sizes for different classes), and programmatically combine the contents of these chosen fields in the input incident record 402 using pre-designed field descriptors to create the description representing the incident. More specifically, the content of each subset of the chosen fields may be preceded by a field-specific piece of text describing the field. According to some implementations, these pre-designed field descriptors may include templates or instructions that describe how each field may be represented in text form. As shown in FIG. 3, each descriptor may include a label or description for the data field. For another example, each descriptor may also define the format in which the field may appear in text (e.g., full sentences, bullet points, etc.), and any conditional logic or formatting rules based on the data (e.g., pluralization, capitalizations). In additional embodiments, the generated textual representation may include information contained in non-textual fields, such as the quantity of chemicals released.

In various aspects, the textual representation generation engine 210 may use the pre-designed field descriptors to define a general template that determines the structure of the final textual output. Such a template may be flexible, allowing optional fields to be skipped if no data is provided. Next, the textual representation generation engine 210 may determine templating logic to process input data (which corresponds to the data fields) and use the descriptors to generate a textual representation. For example, the textual representation generation engine 210 may be configured to loop through all available data fields of the input incident record 402, determine whether each data field is required or if there is available data, format the text for each field according to its descriptor, and generate the final textual output 406.

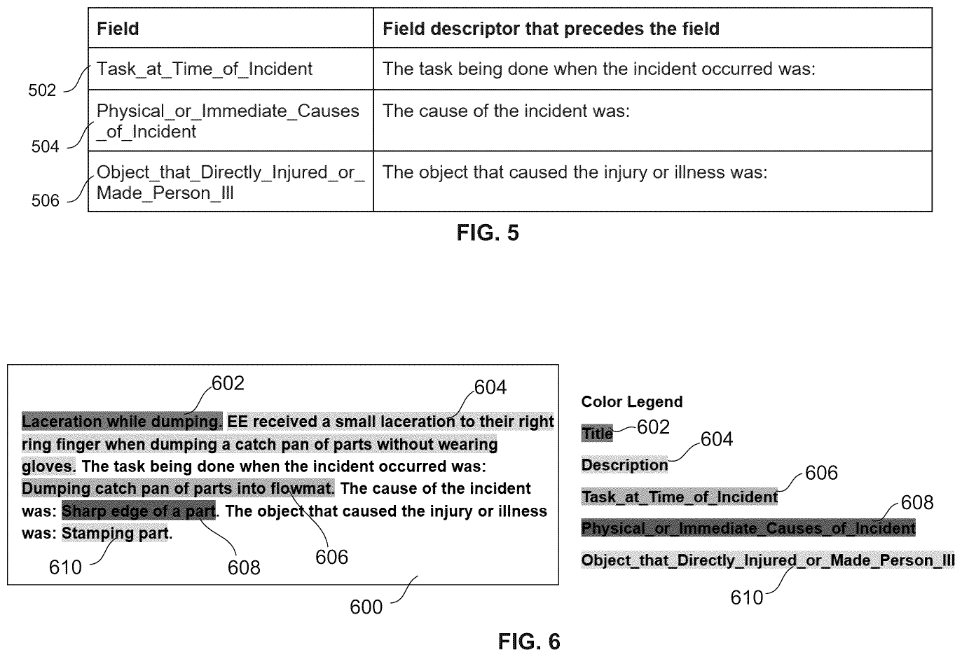

FIG. 5 shows several example field descriptors for some of the fields. Specifically, a first example field 502 in an incident record may specify “Task_at_Time_of_Incident,” and the field descriptor that precedes the field 502 is “The task being done when the incident occurred was:. ” A second example field 504 in an incident record may specify “Physical_or_Immediate_Causes_of_Incident,” and the field descriptor that precedes the field 504 is “The cause of the incident was:.” Further, a third example field 506 in an incident record may specify “Object_that_Directly_Injuried_or_Made_Person_Ill,” and the field descriptor that precedes the field 506 is “The object that caused the injury or illness was:.”

FIG. 6 illustrates an example textual representation of an incident record from select fields. In one embodiment, the left portion of FIG. 6 may represent an incident record 600 which indicates that: “Laceration while dumping. EE received a small laceration to their right ring finger when dumping a catch pan of parts without wearing gloves. The task being done when the incident occurred was: Dumping catch pan of parts into flowmat. The cause of the incident was: Sharp edge of a part. The object that caused the injury or illness was: Stamping part.” The textual representation generation engine 210 may analyze the incident record 600 to identify fields based at least upon a plurality of predetermined fields and field descriptors. As shown in the right portion of FIG. 6, different color legends may be used to highlight certain selected fields. For example, the textual representation generation engine 210 may identify a title portion 602 of the incident record 600 which reads “Laceration while dumping” using a first color scheme. Next, a description portion 604, which reads “EE received a small laceration to their right ring finger when dumping a catch pan of parts without wearing gloves.”, may be highlighted using a second color scheme. Three additional pre-designed field descriptors 606 (“Task_at_Time_of_Incident”), 608 (“Physical_or_Immediate_Causes_of_Incident”), and 610 (“Object_that_Directly_Injuried_or_Made_Person_Ill”) and different color legends may be used to correspond to different portions of the incident record 600 which read “Dumping catch pan of parts into flowmat,” “Sharp edge of a part,” and “Stamping part,” respectively.

The server system 114 may store the generated textual representation for each incident record 402 in memory 216 as a trained model. AI/ML models (e.g., LLMs) used by the present disclosure may be fine-tuned on domain-specific labeled datasets (e.g., PSIF-labeled incident records 404) to improve classification performance and align with industry-specific criteria for determining SIF potential. In response to detecting that multiple hazards may be involved in connection with a received incident record, the server system 114 may instruction a selected LLM to generate multi-label outputs that encompass all relevant risk factors.

In an alternate embodiment, the server system 114 may store information related to the generated descriptions of incident records in one of the external data sources or computing systems 116a, 116b, 116c, . . . 116n of FIG. 1. As a result, the predictive model of the present disclosure may be trained offline and can be shared across different computing devices deployed within the computing system 100.

Referring back to FIG. 4, the server system 114 may carry out 408 a ML-based or LLM-based PSIF incident determination based at least upon the received incident record 402 using the PSIF incident determination engine 212. In one aspect, the server system 114 may prompt at least one LLM using at least the programmatically generated textual representation of the incident record 402.

According to some implementations, the PSIF incident determination engine 212 may instruct the LLM to identify PSIF incidents by understanding and analyzing incident descriptions contextually, extracting cause-effect relationships, comparing patterns to known PSIF scenarios, evaluating against regulatory standards or high-risk markers, and generating transparent, confidence-backed explanations for classification. As disclosed previously, incident records may include structured data (e.g., fields like severity, location, root causes) or unstructured (e.g., free-text descriptions of what happened). The LLM may be instructed to use its training to understand the context, severity potential, and narrative description of each incident record, extract relationships like cause and effect (e.g., “Worker slipped due to wet floor, which was caused by a leaking pipe.”), recognize key entities like “slip,” “fall,” “struck by object,” and conditions such as “no personal protective equipment” or “unguarded machinery.” In some examples, the LLM may be instructed to identify linguistic cues or patterns associated with high-severity incidents expressed via words like “fatal,” “severe injury,” “near miss with major potential,” “critical risk,” or “life-threatening situation,” and descriptions involving falls from height, vehicle collisions, entrapment, or chemical exposure. Moreover, the PSIF incident determination engine 212 may instruct the LLM to perform scenario parsing by analyzing hypotheticals from incident details (e.g., “If a coworker had been standing closer, there could have been severe harm”).

According to additional implementations, the LLM may be instructed to identify patterns in the incident record that align with known high-risk or fatality scenarios. For example, for industry-specific risks, the LLM may apply its training knowledge of incidents typical in the specific domain (e.g., falls from height in construction, confined space risks in utilities, etc.). The LLM may also be instructed to identify contributing factors by extracting and evaluating systemic failures or hazards (e.g., “lack of proper guarding,” “inadequate safety protocols,” or “environmental conditions like poor lighting”).

In identifying a PSIF incident, the LLM may be instructed to perform comparative risk assessment by e.g., comparing a received incident record (incident record 402 of FIG. 4) to its learned examples of past incidents that were classified as PSIFs. If any labeled PSIF incident records 404 are available, they may be included as a part of a prompt to the LLM 408. These incidents known to be PSIF incidents 404 may be used to enable in-context learning for the LLM. During in-context learning, the LLM may learn about the task it is being asked to perform from the examples provided in the prompt without the need for model fine-tuning/re-training. A user may include task instructions, examples, or questions directly in an input prompt to the LLM. For example, in a few-shot setup, an example prompt may include multiple input-output pairs as examples, followed by a query. In some implementations, few-shot and zero shot learning may be employed for in-context learning. During few-shot learning, the LLM is given a few labeled examples to infer patterns or relationships. During zero-shot learning, the LLM may use only task instructions without examples. In contrast to traditional machine learning models, in-context learning may not require re-training or fine-tuning the model on task-specific data.

If a specific pattern matches high-severity cases (e.g., “slip and fall on wet surface” combined with “no PPE”), the incident may be flagged as a PSIF. Further, a severity projection analysis may be carried out based on event scaling and consequences analysis. For example, the LLM may analyze phrases describing how serious the event could have been (e.g., “fall avoided at the last second” or “object fell near workers but missed”) and evaluates what could have happened versus what actually happened.

In various aspects, the LLM may be instructed to use its training on industry safety regulations (e.g., OSHA guidelines, ISO 45001) and general knowledge to classify the severity of an incident. For example, the LLM may determine whether any described risks align with safety thresholds for PSIF classification and provides detailed reasoning, such as: “This incident involves a fall hazard of >6 feet without fall protection, which qualifies as a PSIF under standard X,” or “Exposure to chemical vapors in this record poses significant health risks, justifying classification as a PSIF.”

In additional embodiments, the PSIF incident determination engine 212 may perform model optimization by e.g., using lighter models for PSIF incident classification. If a selected LLM has been fine-tuned for specific tasks, smaller models or distillations of the main LLM (e.g., distilBERT) may be configured to deliver results faster while consuming fewer resources. In one example, the LLM may be fine-tuned on task-specific dataset, where the PSIF incident determination engine 212 may retrain the model on a reduced, specific subset to improve processing time and accuracy. Moreover, in certain implementations, quantization may be carried out to convert a selected model's weights from e.g., 32-bit precision to 16-bit or 8-bit to reduce processing latency.

Thereafter, the PSIF label and rationale generation module 214 may be configured to flag an incident as PSIF incident (PSIF incident label 410) and provide the reasoning behind identifying the incident as PSIF (PSIF incident determination rationale 412) via explicit classification or confidence levels. In some examples, the LLM may explicitly label the incident based on inputs and context: “This incident represents a PSIF because it involves a situation with high likelihood of severe injury if the circumstances were slightly altered.”

In other examples, the LLM may output its confidence or risk score associated with the potential severity. For example, LLMs may output logits for each PSIF classification. Logits are raw, unnormalized scores indicating the model's confidence before normalization. For a binary classification (e.g., PSIF and Not PSIF), the logits may indicate [2.5, −0.5]. Next, the logits may be converted into probabilities using the softmax function. This normalizes the scores so they sum to 1. For example, after a softmax function is applied, [0.93, 0.07] may indicate a 93% confidence for the PSIF class and 7% for Not PSIF. In another example, the PSIF incident determination engine 212 may map the predicted probability to a risk category to determine a risk score for a received incident record. Example thresholds may include: probability >0.90: high risk; 0.50≤probability ≤0.90: medium risk; and probability <0.50: low risk.

Confidence scores may also be calibrated to align better with real-world outcomes using methods like Platt scaling and temperature scaling. For example, the PSIF incident determination engine 212 may fit a logistic regression model on the logits to output calibrated probabilities. Alternatively, the logits may be adjusted by dividing them by a temperature parameter, smoothing probabilities. When assessing incident severity beyond probabilities, risk scores may additionally involve custom heuristic, regression models, and domain knowledge. For example, the PSIF incident determination engine 212 may combine LLM model's confidence with external risk factors (e.g., equipment type, fall height) using rules or formulae designed based on domain knowledge, supplementary features (e.g., height, location, severity thresholds), and risk multipliers. Domain knowledge may include patterns and conditions associated with high-risk incidents that are not captured entirely by the LLM. Metadata or context not available in the incident description text (e.g., environmental factors, equipment type) may be incorporated. For example, according to certain industries with detailed risk guidelines, specific metrics may be included: IF “fall” AND “height >20 ft” THEN “Critical Risk”.

According to various embodiments, the PSIF incident determination engine 212 may instruct the LLM to flag an incident in response to determining that the incident record 402 may lack critical details (e.g., height of a fall, nature of the hazard) or confidence scores may fall below a predefined threshold (e.g., 50% confidence value). In one example, the PSIF label and rationale generation module 214 may generate data to flag such incident record for further review. The LLM may be instructed to output questions to clarify missing or vague incident details. In one embodiment, the LLM may output: “Unable to classify confidently. Questions: What was the height of the fall? Was protective equipment in use?” In cases of ambiguity, the PSIF incident determination engine 212 may instruct the LLM to apply custom heuristics to make preliminary assessments. An example output may be: “Incident not clearly classifiable. Preliminary heuristic-based assessment: Medium Risk due to lack of detailed information.”

In further embodiments, the PSIF incident determination engine 212 may instruct the LLM to explicitly mark certain incident records as “no decision” classification. As a result, the PSIF label and rationale generation module 214 may generate: “Classification: Undetermined. Rationale: The incident description lacks sufficient detail (e.g., height of fall, use of safety equipment) for a reliable decision.”

In yet another embodiment, the PSIF incident determination engine 212 may instruct the LLM to provide the probabilities of multiple categories and let the end-user decide. For example, the PSIF label and rationale generation module 214 may generate: “Potential Classifications: PSIF: 45%; Not a PSIF: 35%, and Undetermined: 20%. Recommended action: Review further details before final classification.”

In certain implementations, after a PSIF identification, the LLM may be instructed to provide actionable remedial measures, such as proactive recommendations to prevent future PSIFs (e.g., “Install fall protection,” “Provide PPE training”) and/or broader systemic fixes (e.g., “Conduct a risk assessment of similar sites.”).

In an aspect, the PSIF label and rationale generation module 214 may design one or more prompts to instruct the LLM to format its response using hypertext markup language (XML) tags. Instructing the LLM to produce a structured response makes parsing the response to extract the desired information easier and more reliable and may also improve the response quality. For example, regular expressions may be used to extract a binary PSIF label 410 (stating whether the incident is a PSIF incident or not) and the PSIF rationale 412 (containing the reasoning behind the PSIF prediction) contained within XML tags.

Alternatively, the PSIF label and rationale generation module 214 may be configured to adapt the format of the LLM's response to each user 102a, 102b . . . 102n's requirements to ensure that the LLM's outputs fit seamlessly into workflows. For example, JSON may be used for data exchange and may be a good alternative to XML for structured outputs. Tabular formats (e.g., markdown tables) may be useful when the output is to be reviewed in human-readable form, such as documentation or reports. In some cases, hierarchical bullet points may organize information clearly when detailed formatting may not be necessary. YAML is another structured format that is human-readable and used in configuration and scripting contexts. For reports or narratives, structured natural language under headings may provide a professional and human-readable format. When integrating with visualization tools, a flowchart description or steps for graph generation may be included. Further, for integration with data analysis tools, CSV formatting may be used. If the LLM output is intended for integration into other automation or querying systems, the PSIF label and rationale generation module 214 may request results in SQL-like or pseudo-code formats. For semantic applications or advanced integrations, ontological notations like resource description framework or web ontology language may be employed as well.

In one aspect, a plurality of parameters and natural language instructions may be determined for using a language model to determine whether the incident record is a PSIF incident. According to some embodiments, since all OpenAI chat models and Anthropic LLMs are non-deterministic, the PSIF label and rationale generation module 214 may set a tunable parameter of the LLM, such that the responses produced by the LLM are maximally deterministic (i.e., as consistent and predictable as possible). For instance, since the temperature parameter of the LLM controls the randomness of the model's output, a lower temperature value may make the LLM more deterministic, while a higher value encourages more creative and diverse responses. The PSIF label and rationale generation module 214 may set the temperature to 0 or close to 0 for maximal determinism. This may reduce the randomness of PSIF identification, making the model chooses the highest-probability option at each step.

In another embodiment, the maximum number of tokens that the LLM may output may be specified. Since tokens are sub-words, this parameter may specify a limit on the word length of the LLM's response. Additionally, the natural language instructions to the LLM may include the textual representation of the incident, followed by a detailed PSIF definition along with a negative example (“For instance, routine slip, trip, or fall incidents do not constitute PSIF incidents.”). If in-context learning is used, a list of positive (PSIF) incidents may be included in the natural language instructions to the LLM, such that a structured response may be generated by the LLM as disclosed above.

In alternate embodiments, rule-based systems, selected ML models, deep learning, or a hybrid approach may be employed for PSIF incident identification. For example, the PSIF incident determination engine 212 may implement a rule engine to encode PSIF-related condition: if “fall height >6 ft” OR “struck by heavy object” OR “chemical exposure=true,” THEN classify as PSIF (1). In another embodiment, the PSIF incident determination engine 212 may train a classification model like logistic regression, support vector machines (SVMs), or random forests. The inputs to such a classification model may include the programmatically generated textual representation of the incident record 402 and the PSIF-labeled incident records 404 which may be used for supervised training to create binary classifiers. In yet another embodiment, the PSIF incident determination engine 212 may use pretrained language models like BERT, ROBERTa, or task-specific variations fine-tuned on incident data to classify PSIF and non-PSIF incidents. Additionally, a hybrid approach may combine the interpretive abilities of an LLM with automated classification tools. For example, the PSIF incident determination engine 212 may use an LLM to generate a summary and risk indicators from the incident report. A separate rule-based system or classifier may then be used to determine the PSIF incident label 410 based on the LLM outputs.

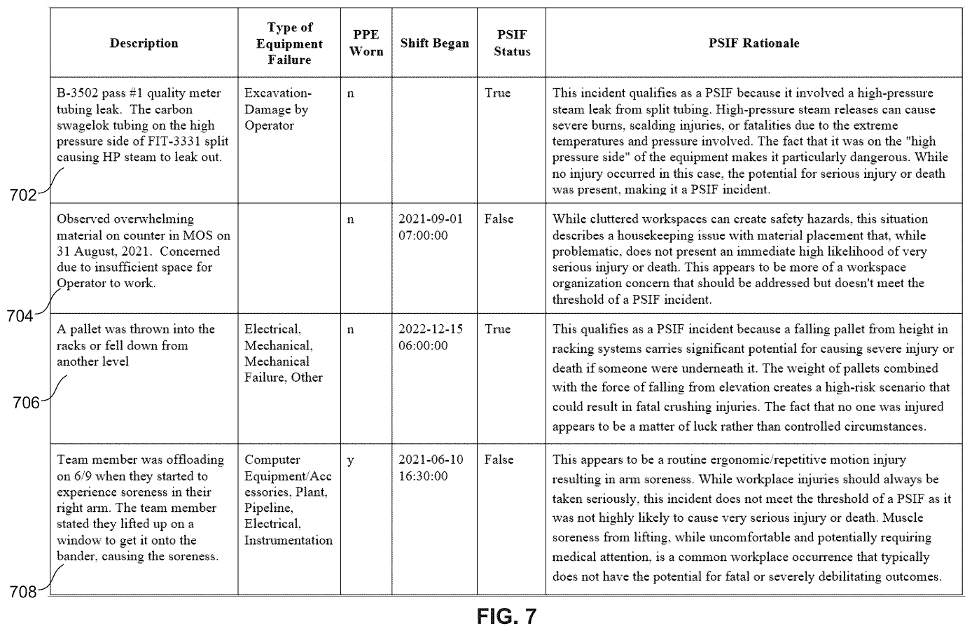

FIG. 7 illustrates a subset of the fields of several incident records along with the corresponding PSIF labels and the rationales/explanations for those labels generated by the computing system 100 of the present disclosure. While the server system 114 of the present disclosure may make use of all fields of each incident record, only four of the 61 columns are shown in FIG. 7 owing to space/presentation considerations. The empty cells in the table of FIG. 7 may denote missing values in the data.

As shown in FIG. 7, the description of a first incident record 702 may indicate that: “B-3502 pass #1 quality meter tubing leak. The carbon swagelok tubing on the high pressure side of FIT-3331 split causing HP steam to leak out.” The textual representation generation engine 210 of the server system 114 may create data to represent this incident using at least a first column “Type of Equipment Failure” as “Excavation-Damage by Operator,” and a second column “PPE_Worn” as “N(o).” The PSIF incident determination engine 212 of the server system 114 may instruct at least one LLM to analyze the first incident record 702, as described above. Thereafter, the PSIF label and rationale generation module 214 may generate a binary indicator “True” to indicate that the first incident record 702 represents a PSIF incident. A brief rationale may also be generated: “This incident qualifies as a PSIF because it involved a high-pressure steam leak from split tubing. High-pressure steam releases can cause severe burns, scalding injuries, or fatalities due to the extreme temperatures and pressure involved. The fact that it was on the ‘high pressure side’ of the equipment makes it particularly dangerous. While no injury occurred in this case, the potential for serious injury or death was present, making it a PSIF incident.”

The description of a second incident record 704 may indicate that: “Observed overwhelming material on counter in MOS on 31 Aug., 2021. Concerned due to insufficient space for Operator to work.” The textual representation generation engine 210 of the server system 114 may create data to represent this incident using at least a first column “PPE Worn” as “N(o),” and a second column “Shift_Began” may indicate “2021-09-01 07:00:00.” The PSIF incident determination engine 212 of the server system 114 may instruct at least one LLM to analyze the first incident record 704, as described above. Thereafter, the PSIF label and rationale generation module 214 may generate a binary indicator “False” to indicate that the second incident record 704 does not represent a PSIF incident. A brief rationale for such determination may indicate that: “While cluttered workspaces can create safety hazards, this situation describes a housekeeping issue with material placement that, while problematic, does not present an immediate high likelihood of very serious injury or death. This appears to be more of a workspace organization concern that should be addressed but doesn't meet the threshold of a PSIF incident.”

The description of a second incident record 706 may indicate that: “A pallet was thrown into the racks or fell down from another level.” The textual representation generation engine 210 of the server system 114 may create data to represent this incident using at least a first column “Type of Equipment Failure” as “Electrical, Mechanical, Mechanical Failure, Other,” a second column “PPE Worn” as “N(o),” and a third column “Shift_Began” may indicate “2022-12-15 06:00:00.” The PSIF incident determination engine 212 of the server system 114 may instruct at least one LLM to analyze the first incident record 706, as described above. Thereafter, the PSIF label and rationale generation module 214 may generate a binary indicator “True” to indicate that the second incident record 706 does represent a PSIF incident. A brief rationale for such determination may indicate that: “This qualifies as a PSIF incident because a falling pallet from height in racking systems carries significant potential for causing severe injury or death if someone were underneath it. The weight of pallets combined with the force of falling from elevation creates a high-risk scenario that could result in fatal crushing injuries. The fact that no one was injured appears to be a matter of luck rather than controlled circumstances.”

The description of an incident record 708 may indicate that: “Team member was offloading on 6/9 when they started to experience soreness in their right arm. The team member stated they lifted up on a window to get it onto the bander, causing the soreness.” The textual representation generation engine 210 of the server system 114 may use multiple columns to represent this incident. For example, a first column “Type of Equipment Failure” may indicate “Computer Equipment/Accessories, Plant, Pipeline, Electrical, Instrumentation,” a second column “PPE Worn” has a column value “Y(es)”, and a third column “Shift_Began” as “2021-06-10 16:30:00.” The PSIF incident determination engine 212 of the server system 114 may instruct at least one LLM to analyze the first incident record 706, as described above. Next, the PSIF label and rationale generation module 214 may generate a binary indicator “True” to indicate that the fourth incident record 708 does not represent a PSIF incident. A brief rationale for such determination may indicate that: “This appears to be a routine ergonomic/repetitive motion injury resulting in arm soreness. While workplace injuries should always be taken seriously, this incident does not meet the threshold of a PSIF as it was not highly likely to cause very serious injury or death. Muscle soreness from lifting, while uncomfortable and potentially requiring medical attention, is a common workplace occurrence that typically does not have the potential for fatal or severely debilitating outcomes.”

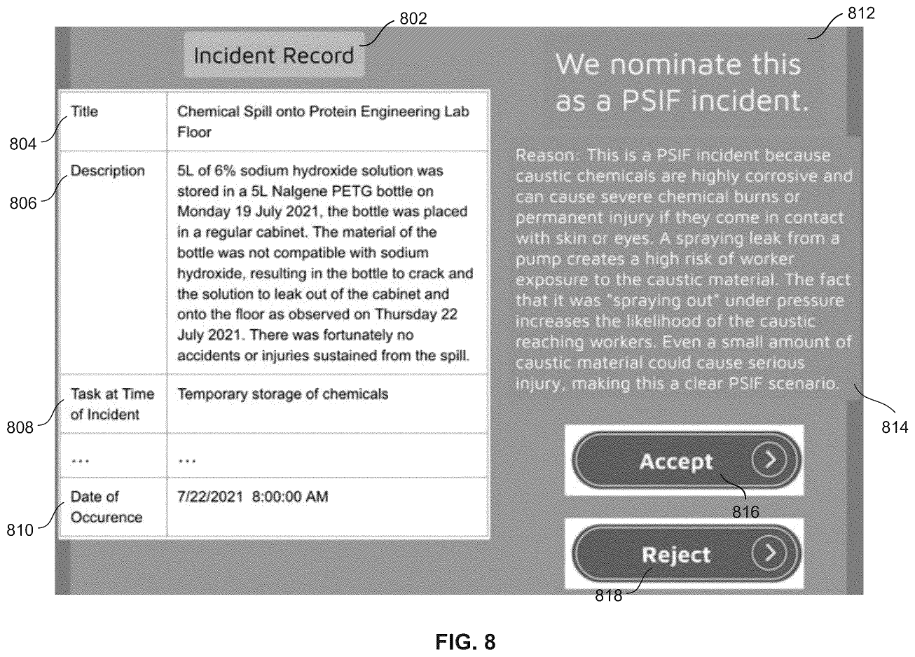

FIG. 8 illustrates an example user interface for displaying the PSIF determination results generated by the computing system 100, in accordance with aspects of the present disclosure. Such user interfaces may be part of an application downloaded and installed on the selected computing device or system 104, 106, or 108. The incident record 802 and the details of the incident record 802 may be displayed on the left, according to one example. Specifically, the incident record 802 may show details of an incident including but not limited to a title of the incident 804, a brief description of the incident 806, the task at time of incident 808, the date of occurrence 810, etc.

Depending on the PSIF label provided by the selected LLM, the computing system 100 of the present disclosure may determine whether to nominate the incident as a PSIF incident. As shown in FIG. 8, in one example, the computing system may nominate the incident record 802 as a PSIF incident 812. A rationale for the nomination or lack thereof 814 may also be displayed. In some aspects, the user may be afforded the ability to accept (a first user interface element 816) or reject (a second user interface element 818) the nomination 812. The user's decision may be saved in a corresponding data storage unit. In alternate embodiments, remedial measures or risk management recommendations (not shown) of the hazards identified in the incident record 802 may also be displayed to the user.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A”or “B”or“A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated.

1: A system deployed within a communication network for identifying potential serious injuries and fatalities (PSIF) incidents from incident records, the system comprising:
a computing device, comprising:
a non-transitory computer readable storage medium storing instructions; and
a processor coupled to the non-transitory computer readable storage medium and configured to execute the instructions to:
obtain an incident record,
identify fields included in the incident record in connection with a set of predetermined field descriptors,
generate a textual description of the incident record based on selected fields of the incident record corresponding to the set of predetermined field descriptors,
determine a plurality of parameters and natural language instructions for using a language model to determine whether the incident record is a PSIF incident,
instruct the language model to perform a machine-learning based binary classification to generate a PSIF label or a non-PSIF label for the incident record based at least upon the plurality of parameters and natural language instructions and the textual description of the incident record,
instruct the language model to generate a rationale explaining a determination of the PSIF label or the non-PSIF label for the incident record, and
generate data for a display device to indicate the PSIF label or the non-PSIF label for the incident record and the rationale thereof.

2: The system of claim 1, wherein the processor of the computing device is further configured to execute the instructions to:
generate a first user interface element for the display device to allow an acceptance of the PSIF label or the non-PSIF label for the incident record; and
generate a second user interface element for the display device to allow a rejection of the PSIF label or the non-PSIF label for the incident record.

3: The system of claim 1, wherein the processor of the computing device is further configured to execute the instructions to:
receive one or more labeled PSIF incident records; and
instruct the language model to perform the machine-learning based binary classification to generate the PSIF label or the non-PSIF label for the incident record based at least upon the plurality of parameters and natural language instructions, the textual description of the incident record, and the one or more labeled PSIF incident records.

4: The system of claim 3, wherein the natural language instructions are configured to instruct the language model to perform in-context learning based at least upon the one or more labeled PSIF incident records in classifying the PSIF label or the non-PSIF label for the incident record.

5: The system of claim 1, wherein the incident record includes a plurality of heterogeneous fields including at least one of: a unstructured text input with a number of unique values, a categorical input with a number of unique textual values, a quantity-based input including numeric values and associated textual information, and date and time information relating to a workplace incident.

6: The system of claim 1, wherein the plurality of parameters instruct the language model to produce a structured response to represent the PSIF label or the non-PSIF label for the incident record and the rationale thereof using hypertext markup language (XML) tags.

7: The system of claim 6, wherein the plurality of parameters set a tunable parameter of the language model to produce the structured response maximally deterministic.

8: The system of claim 1, wherein the processor of the computing device is further configured to execute the instructions to transmit the plurality of parameters and natural language instructions and the textual description of the incident record to the language model via an application programming interface (API).

9: The system of claim 8, wherein the processor of the computing device is further configured to execute the instructions to receive the PSIF label or the non-PSIF label for the incident record and the rationale thereof via the API.

10: The system of claim 1, wherein the language model comprises at least one generative pre-trained transformer model.

11: A computer-implemented method for identifying potential serious injuries and fatalities (PSIF) incidents from incident records, the computer-implemented method comprising:
obtaining, by a processor of a computing device, an incident record;
identifying, by the processor of the computing device, fields included in the incident record in connection with a set of predetermined field descriptors;
generating, by the processor of the computing device, a textual description of the incident record based on selected fields of the incident record corresponding to the set of predetermined field descriptors;
determining, by the processor of the computing device, a plurality of parameters and natural language instructions for using a language model to determine whether the incident record is a PSIF incident;
instructing, by the processor of the computing device, the language model to perform a machine-learning based binary classification to generate a PSIF label or a non-PSIF label for the incident record based at least upon the plurality of parameters and natural language instructions and the textual description of the incident record;
instructing, by the processor of the computing device, the language model to generate a rationale explaining a determination of the PSIF label or the non-PSIF label for the incident record; and
generating, by the processor of the computing device, data for a display device to indicate the PSIF label or the non-PSIF label for the incident record and the rationale thereof.

12: The computer-implemented method of claim 11, further comprising:
generating, by the processor of the computing device, a first user interface element for the display device to allow an acceptance of the PSIF label or the non-PSIF label for the incident record; and
generating, by the processor of the computing device, a second user interface element for the display device to allow a rejection of the PSIF label or the non-PSIF label for the incident record.

13: The computer-implemented method of claim 11, further comprising:
receiving one or more labeled PSIF incident records; and
instructing the language model to perform the machine-learning based binary classification to generate the PSIF label or the non-PSIF label for the incident record based at least upon the plurality of parameters and natural language instructions, the textual description of the incident record, and the one or more labeled PSIF incident records.

14: The computer-implemented method of claim 13, wherein the natural language instructions are configured to instruct the language model to perform in-context learning based at least upon the one or more labeled PSIF incident records in classifying the PSIF label or the non-PSIF label for the incident record.

15: The computer-implemented method of claim 11, wherein the incident record includes a plurality of heterogeneous fields including at least one of: a unstructured text input with a number of unique values, a categorical input with a number of unique textual values, a quantity-based input including numeric values and associated textual information, and date and time information relating to a workplace incident.

16: The computer-implemented method of claim 11, wherein the plurality of parameters instruct the language model to produce a structured response to represent the PSIF label or the non-PSIF label for the incident record and the rationale thereof using hypertext markup language (XML) tags.

17: The computer-implemented method of claim 16, wherein the plurality of parameters set a tunable parameter of the language model to produce the structured response maximally deterministic.

18: The computer-implemented method of claim 11, further comprising transmitting, by the processor of the computing device, the plurality of parameters and natural language instructions and the textual description of the incident record to the language model via an application programming interface (API).

19: The computer-implemented method of claim 18, further comprising receiving, by the processor of the computing device, the PSIF label or the non-PSIF label for the incident record and the rationale thereof via the API.

20: The computer-implemented method of claim 11, wherein the language model comprises at least one generative pre-trained transformer model.
